(19) United States
(12) Patent Application Publication
(10) Pub. No.: US 2017/0042138 A1
(43) Pub. Date: Feb. 16, 2017

(54) MOTION DECOY WITH BIAXIAL WING BEAT

(71) Applicant: Cabela's Incorporated, Sidney, NE (US)

(72) Inventors: Stephen Oshgan, Des Plaines, IL (US); Paresh Shroff, Palatine, IL (US)

(21) Appl. No.: 15/235,578

(22) Filed: Aug. 12, 2016

Related U.S. Application Data
(60) Provisional application No. 62/205,423, filed on Aug. 14, 2015.

(51) Int. Cl. A01M 31/06

(52) U.S. Cl. CPC A01M 31/06

(57) ABSTRACT

A waterfowl motion decoy having a hollow body shaped in the form of a waterfowl and at least one wing member shaped in the form of a waterfowl wing is provided. The decoy comprises a gear train and a swivel joint. The gear train is coupled to a drive shaft driven by a force. The swivel joint includes a wing adapter configured to be couple to a wing member. The swivel joint is coupled to the body of the decoy and the gear train so that, when the gear train is driven by the force, the swivel joint pivots the wing adapter about a pivot axis and rotate the wing adapter about a rotation axis. The pivot axis and the rotation axis are not parallel to each other.

### CROSS-REFERENCE TO RELATED APPLICATION(S)

This application claims priority to co-pending U.S. Provisional Patent Application No. 62/205,423, filed Aug. 14, 2015, which is entirely incorporated herein by reference.

### STATEMENT OF FEDERALLY SPONSORED RESEARCH OR DEVELOPMENT

Not applicable.

### FIELD OF THE DISCLOSURE

This disclosure relates to gaming decoys, and in particular to waterfowl decoys having simulated wing motion.

### BACKGROUND

Decoys are well known and used by waterfowlers to lure live birds within shooting range. Traditionally, such decoys were carved of wood or cork. Now it is commonplace to mold the decoy body from plastic. The decoys can be static with no moving parts, either in full body with legs or with a keel, which can be weighted to maintain an upright position when on water. Static decoys are suited for replicating waterfowl at rest or floating on water. Motion decoys, on the other hand, are intended to replicate a bird in flight and provide a more realistic representation of the bird.

One common type of motion decoy is a spinner-type decoy. Spinner decoys have wings that revolve about a single axis with respect to the decoy body. The wings are typically made of fabric or thin plastic material, such as PVC, and are coupled to a battery powered motor within the body of the decoy. The wings can be coupled directly to the shafts of two motors or a single double-ended motor. The wings could also be coupled to the motor by a belt and pulley arrangement. The wings are generally unrealistic with plain coloring, usually of contrasting colors on each to create a flash of color (such as white) as the wings revolve. However, some spinner decoys have wings with decals or printing that resembles feathers. Some are even flocked with fibers or other materials to provide greater realism.

Another common type of motion decoy is a flapper-type decoy. Flapper decoys can have similar wing structures as spinner decoys, but they differ in that rather than simply revolving the wings, they are driven to impart an angular motion to the wings. One common way to achieve such angular movement is by connecting the inner ends of the wings to the decoy body, such as by hinges, and then rotatably coupling the wings to bent drive shafts. As the drive shafts rotate with respect to the wings, they pull and push on the wings to move them up and down about their hinges. Such angular movement creates a flapping motion that is better suited to replicate a bird in flight than the static decoys.

One problem with existing motion decoys is that the angular motion imparted to the wings does not present a realistic wing beat motion. Due to the bent shaft mechanism used to move the wings in the typical flapper decoy, the wings sweep through only an acute angle that is significantly less than that of live waterfowl. Also, due to the hinged connection of the wings the typical flapper decoy pivots each wing about a single axis albeit at an angle to the motor shaft axis unlike in spinner decoys. The existing motion decoys thus lack the realism of the compound movements that occur during the wing beat of live waterfowl. Moreover, simulating a flight motion in the manner similar to the prior motion decoys does not present the live waterfowl with a naturally inviting environment and motion indicative of landing. As a result, existing motion decoys have become counterproductive in that their lack of realism has effectively become a marker for astute waterfowl to avoid.

This disclosure addresses these problems.

### SUMMARY

The present disclosure overcomes the aforementioned drawbacks by providing a waterfowl motion decoy that the wings of the decoy do not just rotate about one axis. The wings of the decoy can move back and forth in substantially linear paths and rotate when they reach the ends of the ranges of the back-and-forth paths.

A waterfowl motion decoy having a hollow body shaped in the form of a waterfowl and at least one wing member shaped in the form of a waterfowl wing is provided. The decoy comprises a gear train and a swivel joint. The gear train is coupled to a drive shaft driven by a force. The swivel joint includes a wing adapter configured to couple to a wing member. The swivel joint is coupled to the body of the decoy and the gear train so that, when the gear train is driven by the force, the swivel joint pivots the wing adapter about a pivot axis and rotates the wing adapter about a rotation axis. The pivot axis and the rotation axis are not parallel to each other.

### BRIEF DESCRIPTION OF THE DRAWINGS

FIGS. 1(A)-(B) show an example motion decoy chassis that can be placed inside a decoy in the form of a waterfowl.

FIGS. 2(A)-(B) show top and bottom compartments of an example motion decoy chassis when the chassis is taken apart along its midline.

FIGS. 3(A)-(B) show an example swivel joint.

FIGS. 4(A)-(C) show three different movement modes of an example pivot arm.

FIGS. 5(A)-(B) illustrate the movement of an example swivel joint when the pivot arm is constrained against co-rotating with the rotating shaft by a counter weight.

FIG. 6 shows an example counter weight.

FIG. 7 shows an example decoy with the pivot arm constrained from co-rotating with the rotating shaft by a housing.

FIG. 8 shows an example decoy with more than one pivot arm.

FIG. 9 illustrates a body of an example waterfowl motion decoy with a single pair of wings illustrated at six different positions, where each position is a location of the wings at a different time during the movement of the wings.

FIG. 10 illustrates a body of an example waterfowl motion decoy with an opening.

FIG. 11 illustrates a top view of an example wing used with a waterfowl motion decoy.

FIG. 12 illustrates a bottom view of an example wing used with a waterfowl motion decoy.

FIG. 13 illustrates an example waterfowl motion decoy mounted on a stake during use in the field.

FIG. 14 illustrates how a wing may be mounted to a body or housing of the waterfowl motion decoy.

FIGS. 15-16 illustrate the waterfowl motion decoy with the wings as mirror images of each other as the wings move up and down about a pivot axis and rotate back and forth about a rotation axis.

### DETAILED DESCRIPTION

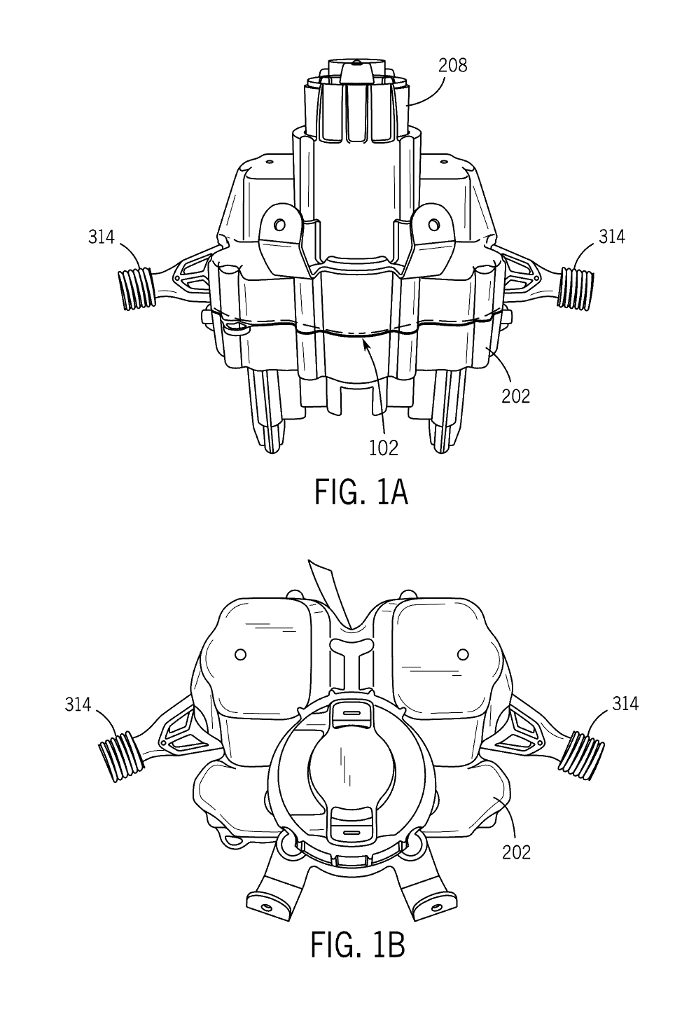

Referring to FIGS. 1(A)-(B), an example motion decoy chassis is shown. The chassis can be mostly housed inside a housing 202, and placed inside a hollow body in the form of a waterfowl in an orientation that the motor mount 208 faces the back or the breast of the waterfowl. The chassis can be coupled with the wings of the waterfowl through the wing adapters 314 such that the wings move in a fashion mimicking a waterfowl in flight. FIG. 1(A) shows the coronal view of the example chassis, and FIG. 1(B) shows the axial view of the example chassis.

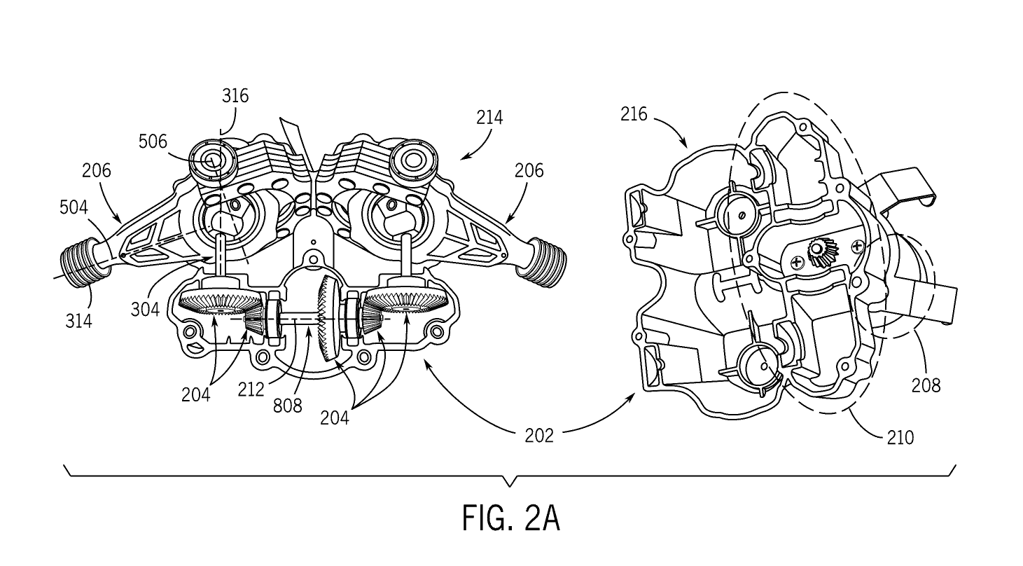

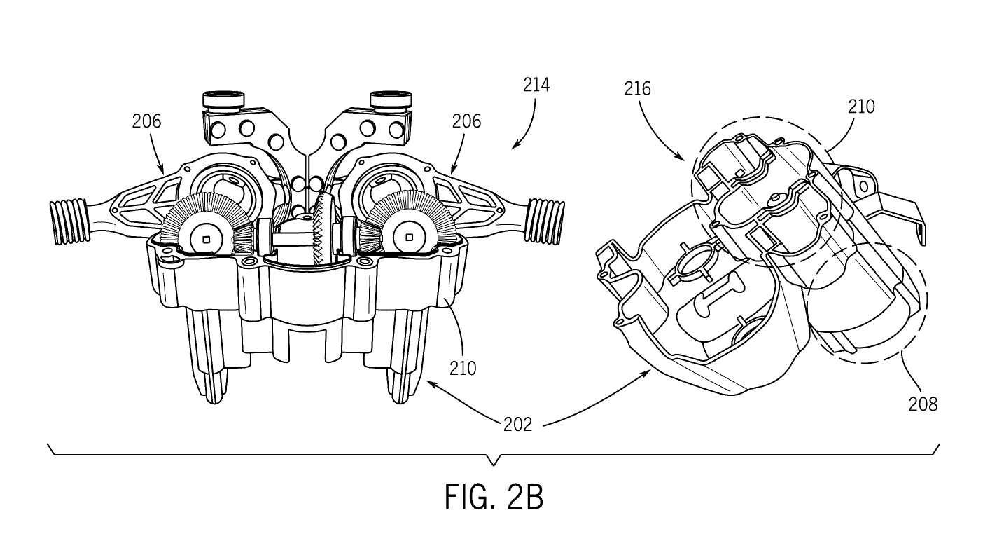

Referring to FIGS. 2(A)-(B), top and bottom compartments (216 and 214) of an example motion decoy chassis are shown when the chassis is taken apart along the midline 102 shown in FIG. 1(A). The top compartment 216 can house a motor mount 208, and the bottom compartment 214 can house a gear train 204 and partially one or more swivel joints 206.

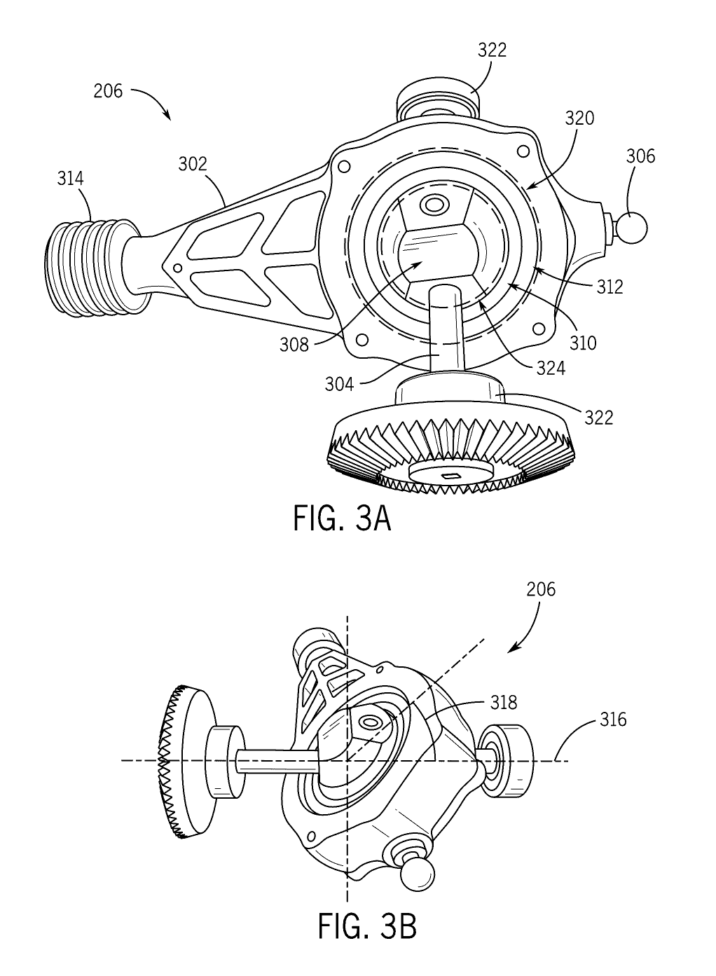

Referring to FIGS. 3(A)-(B), an example swivel joint 206 is shown. The swivel joint 206 comprises a pivot arm 302 and a rotating shaft 304. In one configuration, the pivot arm 302 comprises a ball connection 306 and a wing adapter 314. The pivot arm 302 is a rigid member and can define the wing adapter 314 at one end and a bearing mount 320 (marked by a dashed circle) at the other end. The rotating shaft 304 can include bearings 322 at its opposite ends.

Still referring to FIGS. 3(A)-(B), the rotating shaft 304 can be connected with the pivot arm 302 through a bearing. The bearing comprises an inner race 310 and an outer race 312. The outer race 312 is coupled to the bearing mount 320. The rotating shaft 304 can be mounted on and coupled to the mounting hub 308 for co-rotating with the mounting hub 308. The mounting hub 308 defines an annular mounting surface 324 (marked by a dashed circle). The annular mounting surface 324 is coupled to the inner race 310. In one configuration, the swivel joint can be constructed in a way such that the inner race 310, the mounting hub 308, and the rotating shaft 304 move as one piece, and the outer race 312 and the pivot arm 302 move as one piece. The plane that the pivot arm 302 aligns and the axis 316 of the rotating shaft 304 intersect at an oblique angle 318 (as shown in FIG. 3(B)). In one configuration, the rotating shaft 304 is mounted on the mounting hub 308 in such a manner that the axis centered by the annular mounting surface 324 intersects the rotating shaft 304 at an oblique angle.

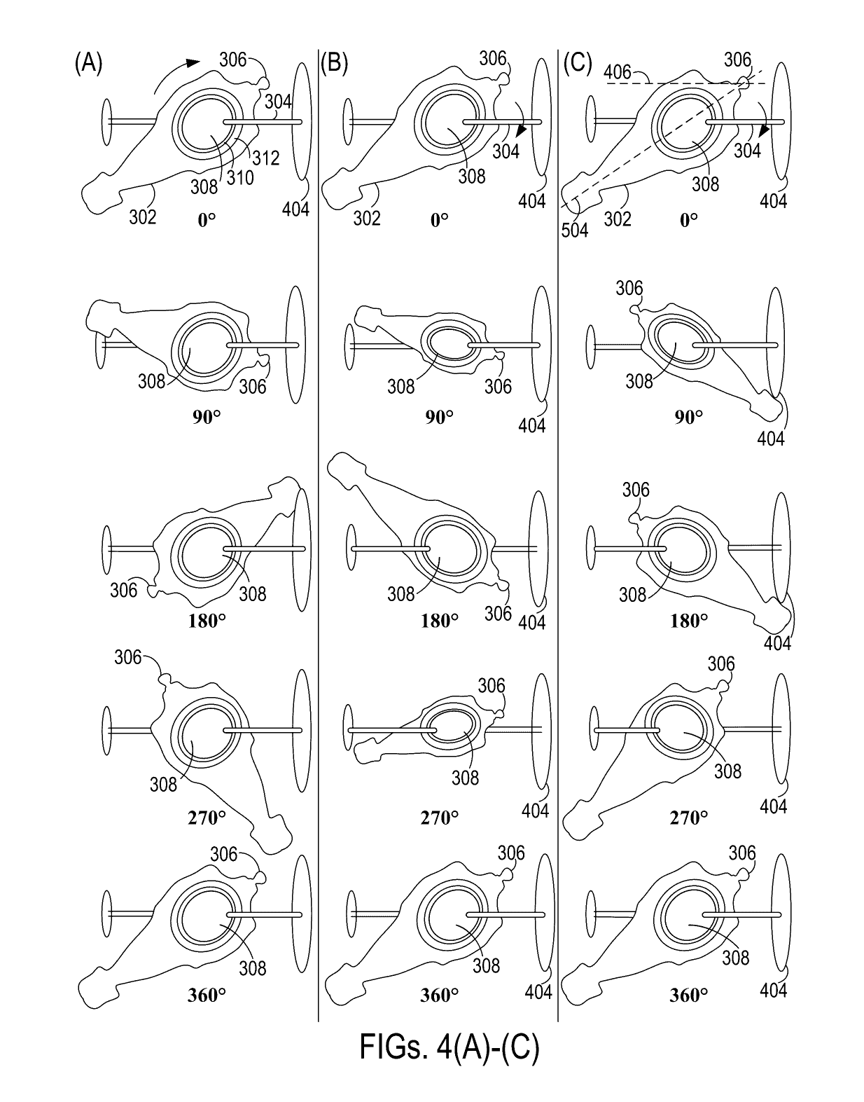

Referring now to FIGS. 4(A)-(C), schematics illustrating three different movement modes of an example pivot arm 302 are provided. The schematics serve as illustrative, non-limiting examples. In the mode illustrated in FIG. 4(A), the rotating shaft 304 does not rotate and the pivot arm 302 rotates around the mounting hub 308 in a direction marked by an arrow. Such rotation of the pivot arm 302 is enabled by the bearing structure comprising an inner race 310 and an outer race 312. As an illustrative example, the ball connection 306 of the pivot arm 302 points away from a viewer and the mounting side of the mounting hub 308—the side of the mounting hub 308 that faces the gear 404—faces towards the viewer at the starting position (position 0°). When the pivot arm 302 rotates by 90°, the ball connection 306 would point down. When the pivot arm 302 rotates further to the 180° position, the ball connection 306 would point towards the viewer. When the pivot arm 302 rotates to the 270° position, the ball connection 306 would point up. When the pivot arm 302 rotates to the 360° position, the ball connection 306 would return to the starting position and point away from the viewer. During the rotation, the mounting hub 308 does not rotate because it is coupled with the rotating shaft 304 and, thus, the mounting side of the mounting hub 308 remains facing the viewer. In this mode, the pivot arm 302 moves up and down, and left and right.

In the mode illustrated in FIG. 4(B), the pivot arm 302 co-rotates with the rotating shaft 304—i.e., the pivot arm 302 does not rotate around the mounting hub 308 as shown in FIG. 4(A), instead rotating with the mounting hub 308 as one piece around the rotating shaft 304. The pivot arms 302 starts at the same position as that in FIG. 4(A). When the rotating shaft 304 rotates by 90° in the direction marked by an arrow, the ball connection 306 points down. When the rotating shaft 304 rotates to the 180° position, the ball connection 306 points towards the viewer, and the mounting hub 308 has also rotated 180° as the side of the hub facing the gear 404 faces away from the viewer. Compared with the mode illustrated in FIG. 4(A), the ball connection 306 remains point towards the gear 404, instead of pointing away as shown in the 180° position plot of FIG. 4(A). When the rotating shaft 304 rotates to the 270° position, the ball connection 306 points up but still towards the gear 404. When the rotating shaft 304 rotates to the 360° position, the ball connection 306 and the mounting hub 308 return to the starting position where the ball connection 306 points away from the viewer and the mounting side of the mounting hub 308 faces towards the viewer. In this mode, the ball connection 306 always points towards the gear 404 and the pivot arm 302 does not move left and right, only up and down.

In the mode illustrated in FIG. 4(C), the movement of the pivot arm 302 is illustrated when the pivot arm 302 is constrained from co-rotating with the rotating shaft 304. In one configuration, the up-and-down motion of the pivot arm 302 is constrained and the pivot arm 302 does not rotate together with the mounting hub 308 as one piece as shown in FIG. 4(B). In one configuration, the pivot arm 302 does not move up and down and, as a result, the vertical position of the ball connection 306 stays along a line 406 parallel to the rotating shaft 304. As the rotating shaft 304 rotates, the mounting hub 308 rotates with it as shown in FIG. 4(B) and drives the pivot arm 302 to move left and right and to pivot around the pivot axis 504. In FIG. 4(C), the pivot arm 302 also starts at the same position as that in FIG. 4(A). When the rotating shaft 304 rotates by 90° in the direction marked by an arrow, the up-and-down motion of the pivot arm 302 is constrained, and the pivot arm 302 is forced to pivot around its pivot axis 504 and drives the ball connection 306 to move to the far left. When the rotating shaft 304 rotates to the 180° position, the ball connection 306 is constrained from moving further left. So the pivot arm 302 pivots around its pivot axis 504 and the side of the mounting hub 308 facing the gear 404 rotates to face away from the viewer so that the ball connection 306 moves to the right. When the rotating shaft 304 rotates to the 270° position, the ball connection 306 returns to the starting position of the far right but with the side of the mounting hub 308 facing the gear 404 still facing away from the viewer. When the rotating shaft 304 rotates to the 360° position, the ball connection 306 is constrained from moving further right. So the pivot arm 302 pivots and the mounting hub 308 returns to the original orientation so that the ball connection 306 moves to the left. In this mode, the pivot arm 302 moves left and right and, at the same time, pivots around its pivot axis 504.

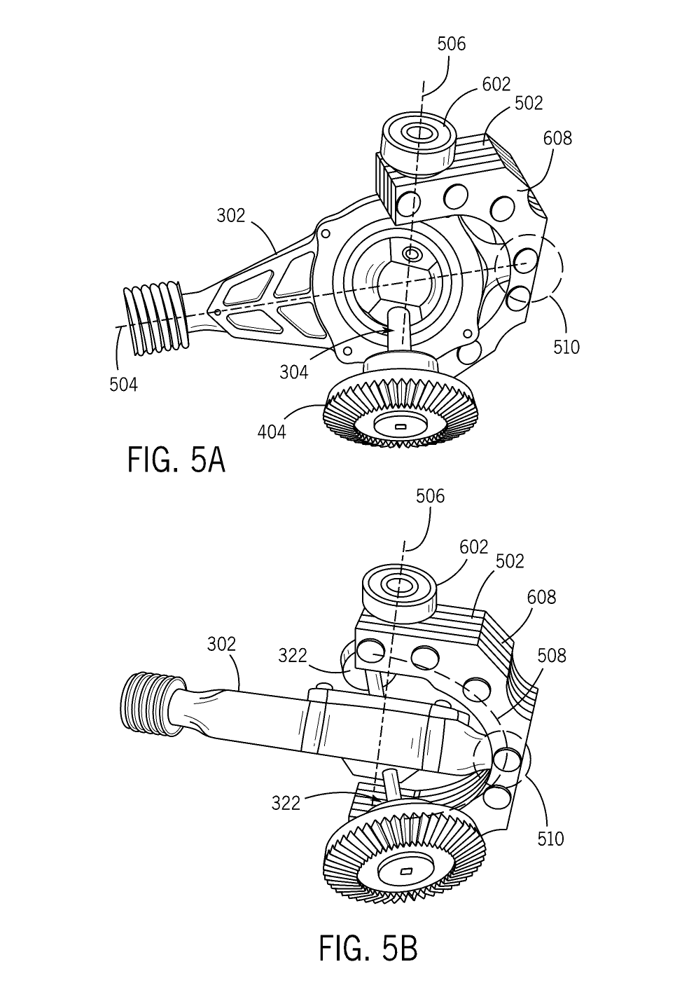

Referring now to FIGS. 5(A)-(B), an example swivel joint when the pivot arm 302 is constrained against co-rotating with the rotating shaft 304 is shown. The pivot arm 302 can be constrained against co-rotating with the rotating shaft 304 by constraining the up-and-down motion of the pivot arm 302. In one configuration, the up-and-down motion is constrained by a counter weight 502.

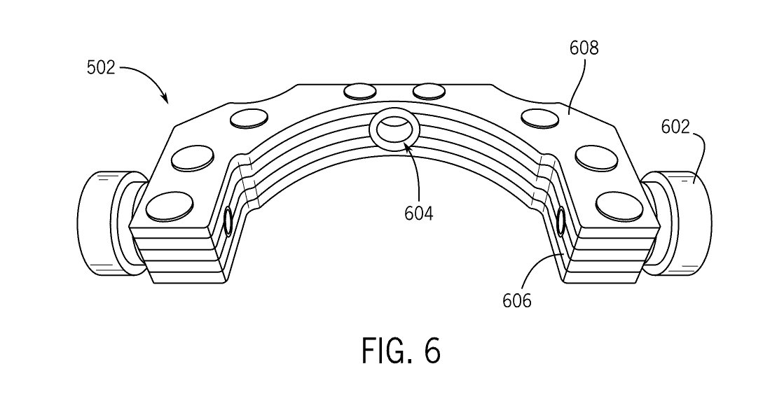

Referring to FIG. 6, an example counter weight 502 is shown. The counter weight 502 can have a C shape and comprise a stack of C-shaped plates that define a socket 604 at the center area of the C-shaped arm 608. The counter weight 502 can fit around the bearing mount end of the pivot arm 302. The counter weight 502 can further comprise bearings 602 at its opposite ends.

Referring back to FIGS. 5(A)-(B), an example counter weight 502 can fit the bearing mount end of an example pivot arm 302 by fitting the ball connection 306 into the socket 604 (with the area marked by a dashed circle 510). This configuration constrains the pivot arm 302 against co-rotating with the rotating shaft 304 by constraining the up-and-down motion of the pivot arm 302, but allows that the ball connection 306 rotates in the socket 604 and therefore the pivot arm 302 rotates about a pivot axis 504. When the gear 404 rotates, the rotating shaft 304 rotates and causes the pivot arm 302 to move. As described above, without the counter weight 502, the pivot arm 302 co-rotates with the rotating shaft 304 and moves up and down, and back and forth. With the counter weight 502, the up-and-down motion of the pivot arm 302 is constrained by the counter weight 502. So when the rotating shaft 304 rotates, the pivot arm 302 moves back and forth, the C-shaped arm 608 rotates together with the pivot arm 302 about the counter-weight pivot axis 506 comprising the bearings 602 at each end of the counter weight 502, and the socket 604 moves along a semicircle 508 with the bearings 322 as the two opposite ends of the diameter of the semicircle 508. The counter-weight pivot axis 506 can intersect the rotating shaft 304 at a right angle. When the C-shaped arm 608 moves to the far end of the semicircle 508, the pivot arm 302 pivots about its pivoting axis 504 and then moves in a linear path in the opposite direction followed with the C-shaped arm 608 rotating back. As shown, the pivot arm 302 in FIG. 5(A) faces in an orientation different from that in FIG. 5(B) due to this pivoting.

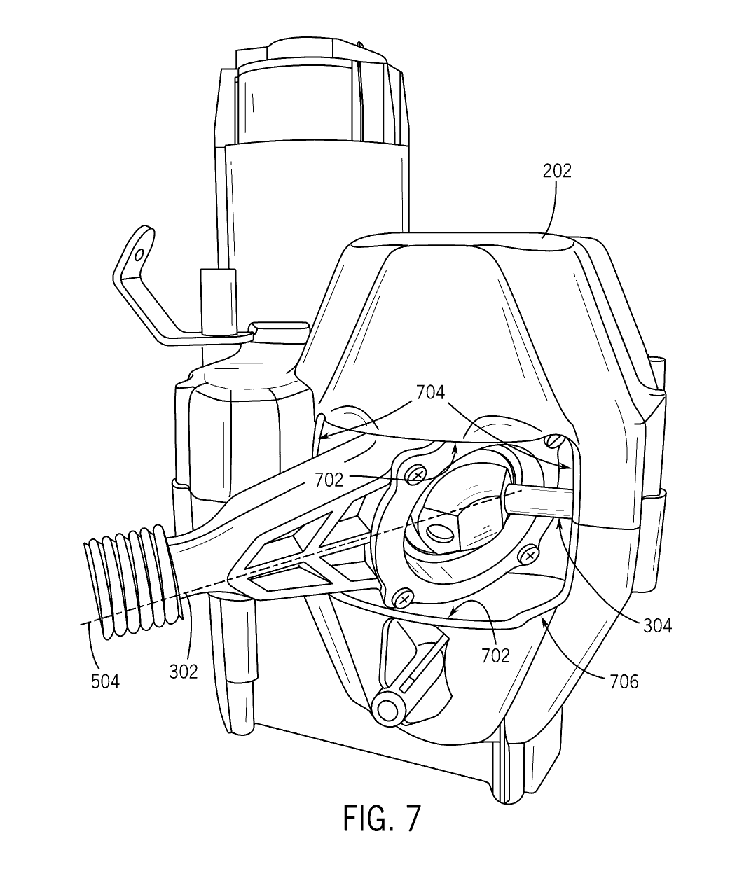

Referring now to FIG. 7, an example chassis with the pivot arm 302 constrained from co-rotating with the rotating shaft 304 by the housing 202 is shown. In one configuration, the pivot arm 302 can be constrained from co-rotating with the rotating shaft 304 by the horizontal edges 702 of the opening 706 in the housing 202. When the rotating shaft 304 rotates, the pivot arm 302 moves back and forth and up and down. When the pivot arm 302 moves up and down and hits the horizontal edges 702, the pivot arm 302 pivots about its pivoting axis 504 so the pivot arm 302 stays in the range of the opening 706. This way, the pivot arm 302 moves along substantially-linear paths. That is, the pivot arm 302 moves back and forth along a linear path and, the same time, up and down in a range constrained by the opening 706. When the pivot arm 302 moves close to the vertical edges 704 of the opening 706, the pivot arm 302 pivots about its pivoting axis 504 and then moves in the opposite direction.

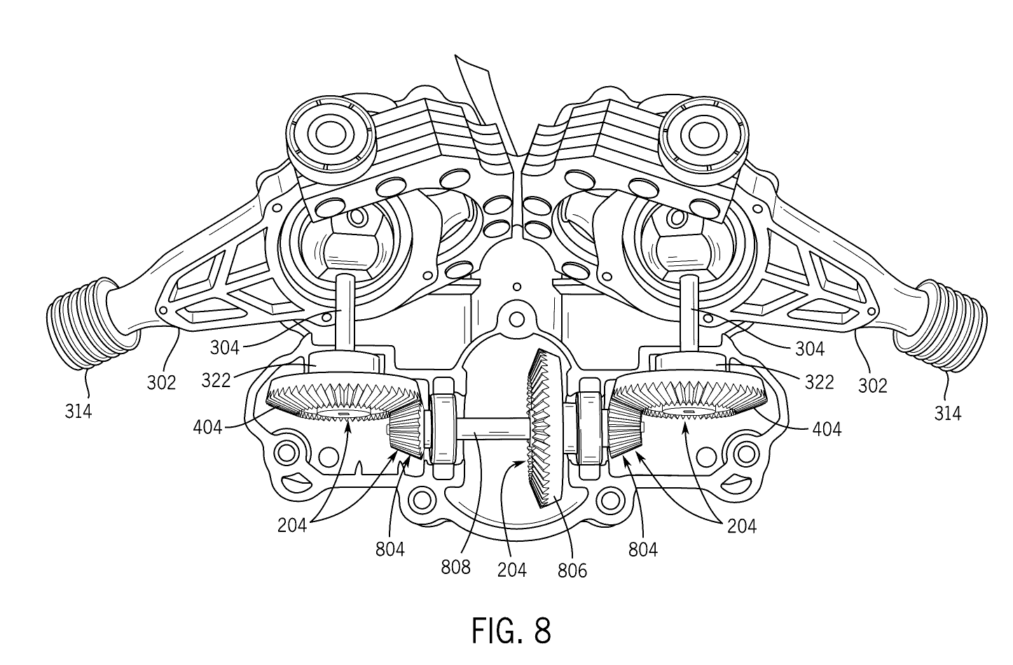

Referring to FIG. 8, an example chassis with more than one pivot arm 302 is shown. The chassis can further comprise a motor mount 208 shown in FIGS. 1(A) and 2(A) and be placed inside a decoy in the form of a waterfowl. The motion of the pivot arm 302 is driven by a gear 404. The two pivot arms 302 can be coupled through a gear train 204. In one configuration, the gear train 204 comprises individual input gears 804, a master input gear 806, gears 404 coupled to the rotating shafts 304. The gears 404 serve as the output gears in the gear train 204, and the individual input gears 804 and the master input gear 806 serve as the input gears. The gear 404 is coupled to the individual input gear 804. The input gears 804 and 806 can be coupled to a drive shaft 808 such that, when the drive shaft 808 moves, the master input gear 806 moves and drives the individual input gears 804, which in turn drive the gear 404 coupled to the rotating shaft 304, the rotating shaft 304, the pivot arm 302, and then the wing adapter 314. As a result, the wings of the decoy can be coupled and move in sync with each other. The wings of the decoy can be driven by forces like a motor or wind. In one configuration, one input gear is used to drive both of the gears 404.

The waterfowl motion decoy can comprise a hollow body shaped in the form of a waterfowl and at least one wing member shaped in the form of a waterfowl wing. Referring back to FIGS. 1(A)-(B), an example chassis can include a housing 202, which can be mounted within the body of the decoy.

Referring to FIGS. 2(A)-(B), the housing 202 can be rigid and defines a motor mount 208 and a gear housing 210. The housing 202 also houses part of the swivel joint 206. The chassis comprises a gear train 204 and a swivel joint 206. The chassis can further comprise a motor. The motor can be housed in the motor mount 208. Referring to FIG. 2(A), the gear train 204 is coupled to a drive shaft 808 rotatable about a drive axis 212. The drive shaft 808 can be driven by a motor. The wing adapter 314 of the swivel joint 206 is configured to couple to a wing member. The swivel joint 206 is coupled to the body of the decoy and can move to pivot the wing adaptor 314 about a pivot axis 504 and rotate the wing adaptor 314 about a rotation axis 506 that is not parallel to the pivot axis 504. In one configuration, the rotation axis 506 aligns with the counter-weight pivot axis 506 (as shown in FIGS. 5(A)-(B)). The two types of motions of the wing adaptor 314 can be simultaneous or occur at different times. When the decoy has more than one wing, the multiple wings can be pivotally mounted to the body on opposite sides of the head-to-toe centerline of the body and coupled to the gear train 204 and timed to pivot with respect to the body as mirror images about the centerline.

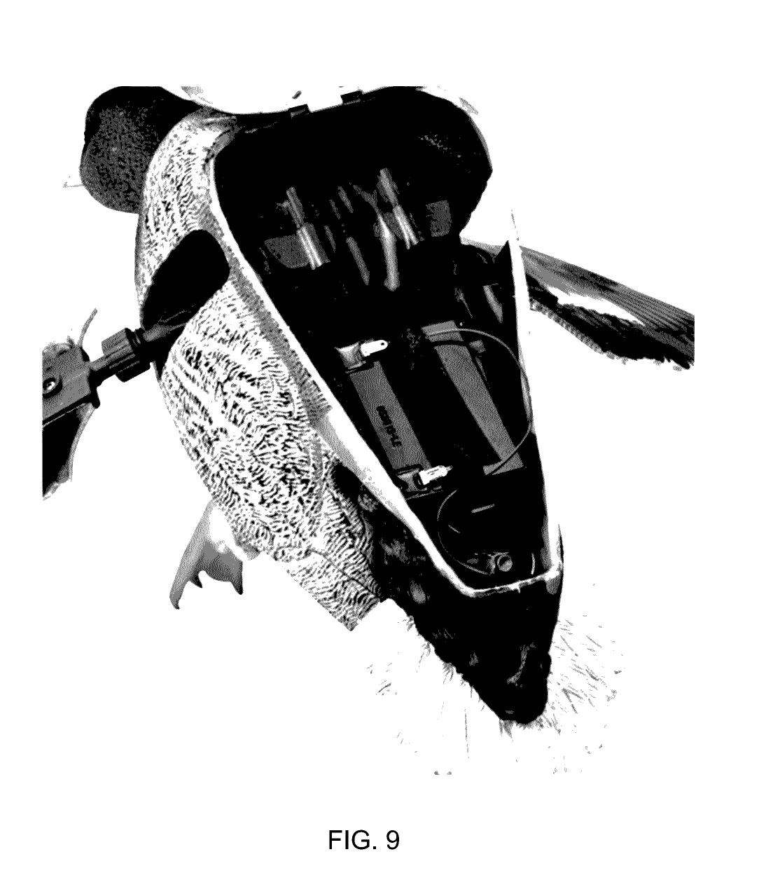

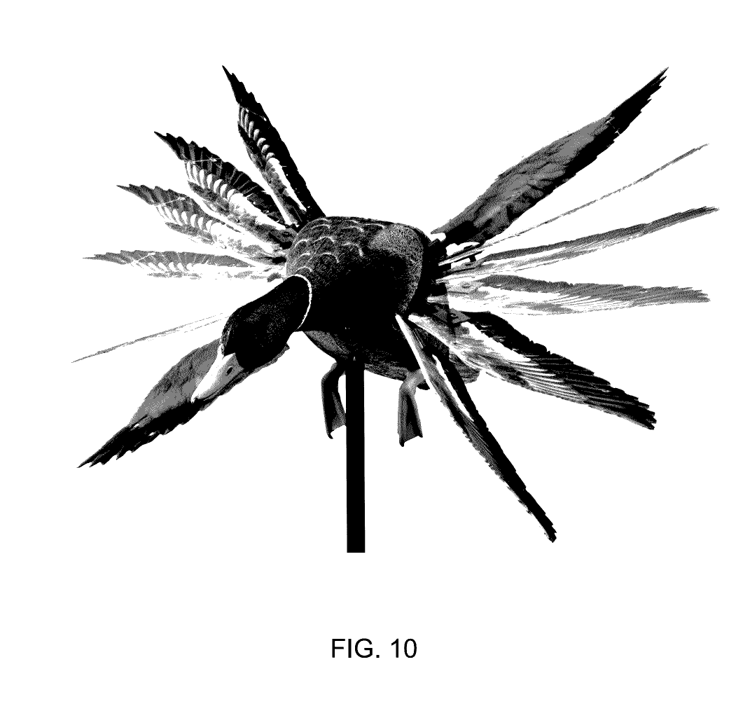

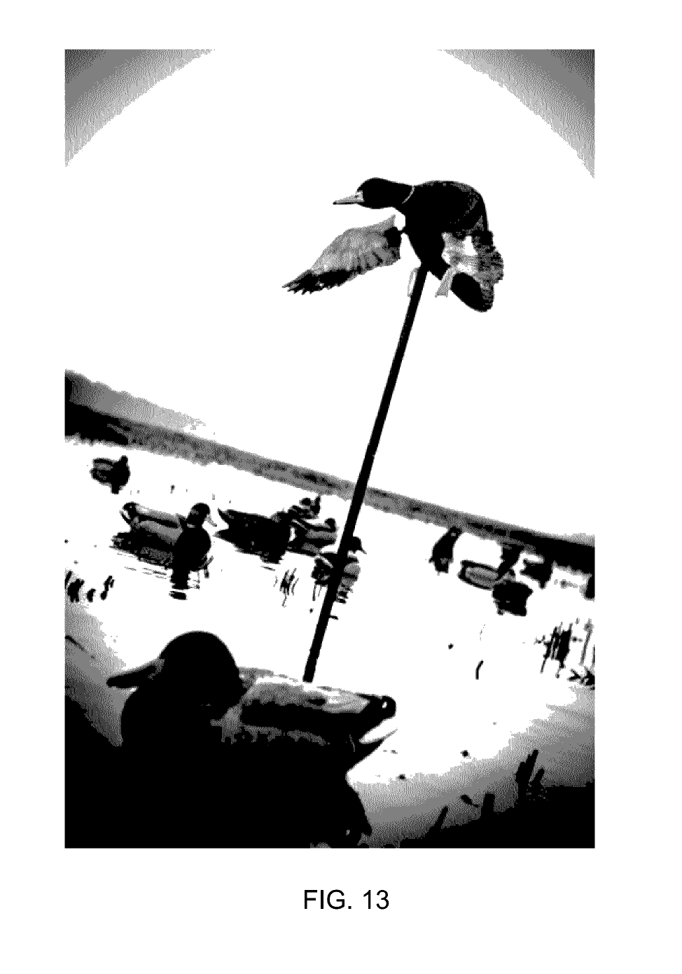

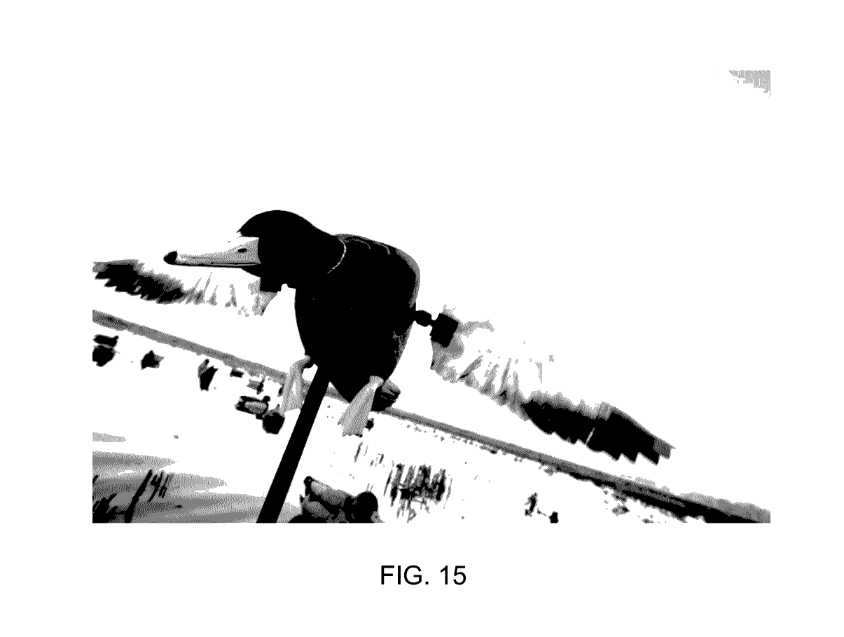

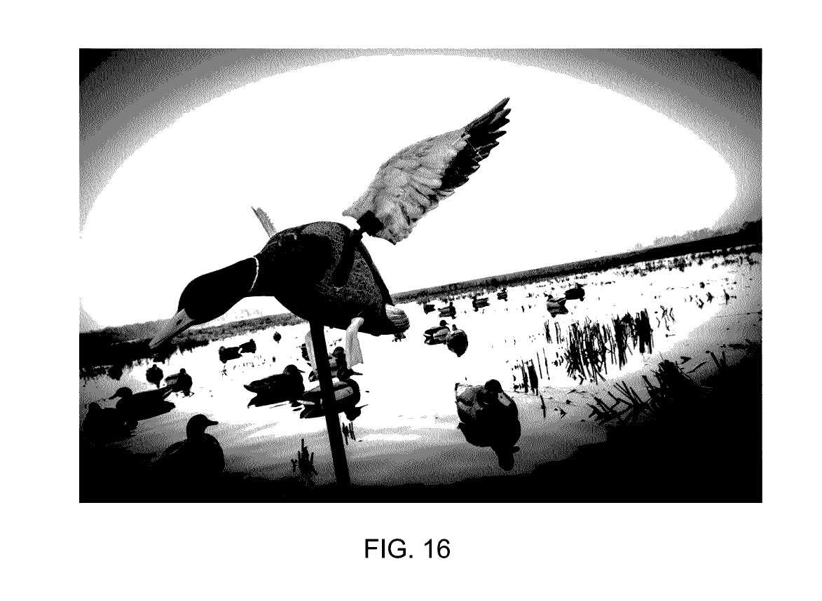

In another embodiment, a waterfowl motion decoy may have a housing 202 designed to look like a body of a bird, such as a waterfowl. Non-limiting examples of the waterfowl motion decoy may be seen in FIGS. 9, 10, 13, 15 and 16. FIGS. 13, 15 and 16 illustrate how the waterfowl motion decoy may be used in the field.

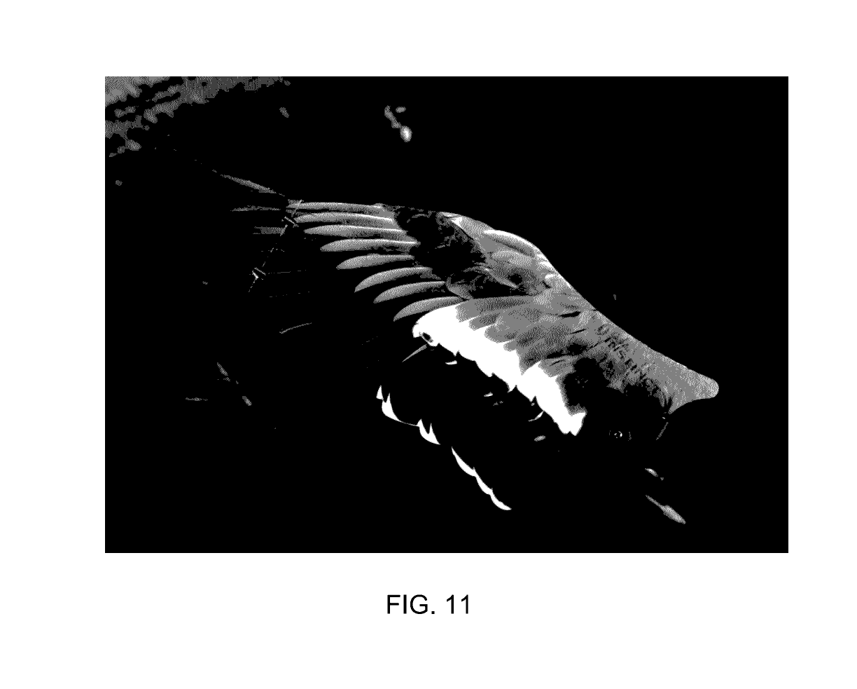

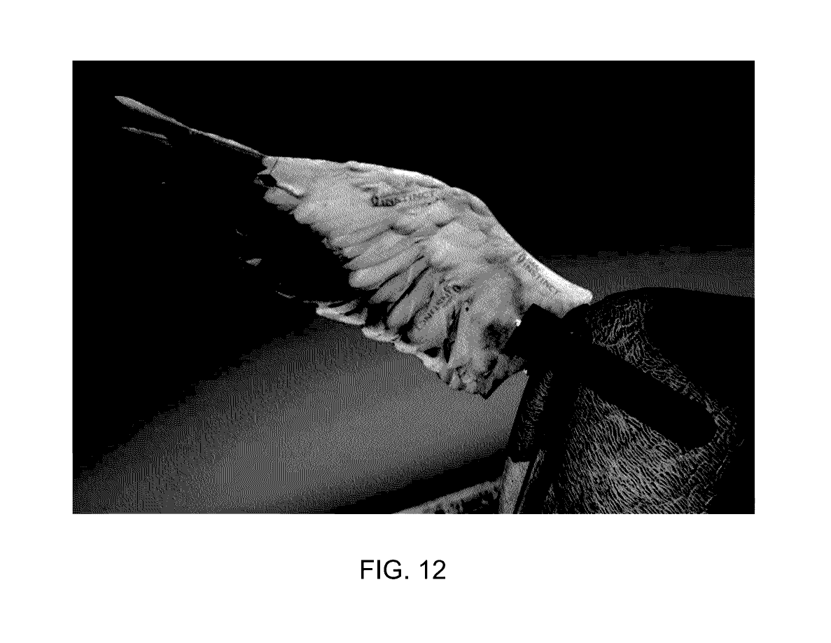

The motion decoy may also include two wings, preferably designed to look as much as possible like wings of a real bird. A top view of a wing may be seen in FIG. 11 and a bottom view of a wing may be seen in FIG. 12. Two swivel joints 206 may be coupled (in a movable manner) to an inside compartment of the housing 202 to allow the wings to move in a realistic manner to the flapping of wings of a bird. FIG. 9 illustrates a body of an example waterfowl motion decoy with a single pair of wings simultaneously illustrated at six different positions (showing six different pairs of wings), where each pair of wings is a location of the wings at a different time during the movement cycle of the wings.

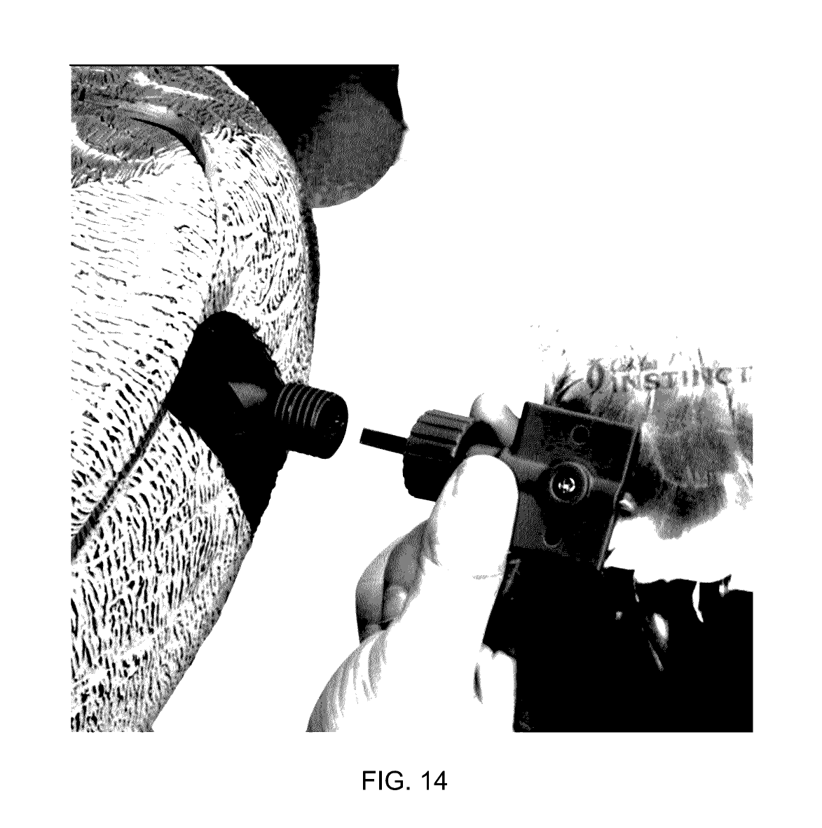

Each swivel joint 206 may have a pivot arm 302 with a wing adapter 314 at a first end and optionally a ball connection 306 at a second end. The wing adapter 314 may be configured to be coupled to a wing using any desired method. As a non-limiting example illustrated in FIG. 14, the wing adapter 314 may have threads that screw into one of the wings to couple the wing adapter 314 to the wing. The pivot arm 302 may also have a bearing mount 320 for receiving a swivel bearing more fully described below.

The swivel joint 206 may also have a rotating shaft 304 with a first rotating bearing 322 and a second rotating bearing 322 at opposite ends of the rotating shaft 304. The swivel joint 206 may also have a swivel bearing connecting the pivot arm 302 to the rotating shaft 304.

The swivel bearing may have an outer race 312 fixed to the bearing mount 320 of the pivot arm 302 so that the outer race 312 and the pivot arm 302 move as one piece. The swivel bearing may also include an inner race 310 coupled to the outer race 312 so that the inner race 310 may freely spin inside the outer race 312. The swivel bearing may also include a mounting hub 308 fixed to the inner race 310. The rotating shaft 304 may extend through the mounting hub 308 so that the inner race 310, the mounting hub 308 and the rotating shaft 304 move as one piece. This configuration allows each swivel joint 206 to move one of the two wings back and forth in a linear path and rotate the wing back and forth when the wing reaches a top and a bottom of the linear path.

In some embodiments, the pivot arm 302 may be constrained from co-rotating with the rotating shaft 304 by a horizontal edge of an opening in the housing 202.

In some embodiments, the ball connection 306 of the pivot arm 302 may be inserted into a socket 604 located in a center area of a counter weight 502, thereby constraining the pivot arm 302 from co-rotating with the rotating shaft 304. Each counter weight 502 may have a bearing 602 at each end of the counter weight 502.

The swivel joint 206 may also be coupled to the housing 202 and a gear train 204 so that, when the gear train 204 is driven by a force, each swivel joint 206 pivots the wing adapter 314 about a pivot axis 504 and rotates the wing adapter 314 about a rotation axis 506. In some embodiments, the pivot axis 504 and the rotation axis 506 intersect at an angle between 30 and 60 degrees and most preferably at an angle of about 45 degrees.

In some embodiments, a gear train 204 may be coupled to a drive shaft 808 driven by a force to generate or create a motion of the wings. As non-limiting examples, the force may be created by a motor powered by a battery and optionally in combination with a solar panel or a wind turbine.

In some embodiments, the waterfowl motion decoy includes a chassis mounted in the housing 202 configured to move each of the two wings back and forth in a linear path and rotate each wing back and forth when the wing reaches a top and a bottom of the linear path. In addition, the chassis may be configured to move the two wings as mirror images about a head-to-toe centerline of the housing 202.

Accordingly, the foregoing detailed description describes the subject of this disclosure in one or more examples. A skilled person in the art to which the subject matter of this disclosure pertains will recognize many alternatives, modifications and variations to the described example(s).

The invention claimed is:

1. A waterfowl motion decoy comprising:
a housing configured to look like a body of the waterfowl;
two wings configured to look like wings of the waterfowl; and
two swivel joints movably coupled to the housing, wherein each swivel joint comprises:
a pivot arm comprising:
a wing adapter at a first end of the pivot arm configured to be coupled to one of the two wings and
a bearing mount,
a rotating shaft having a first rotating bearing and a second rotating bearing at opposite ends of the rotating shaft,
a swivel bearing connecting the pivot arm to the rotating shaft comprising:
an outer race fixed to the bearing mount of the pivot arm so that the outer race and the pivot arm move as one piece,
an inner race coupled to the outer race so that the inner race can freely spin inside the outer race and
a mounting hub fixed to the inner race and the rotating shaft extends through the mounting hub so that the inner race, the mounting hub and the rotating shaft move as one piece and
wherein each of the two swivel joints is configured to move one of the two wings back and forth in a linear path and rotate the wing back and forth when the wing reaches a top and a bottom of the linear path.

2. The waterfowl motion decoy of claim 1, wherein the pivot arm is constrained from co-rotating with the rotating shaft by a horizontal edge of an opening in the housing.

3. The waterfowl motion decoy of claim 1, further comprising:
two counter weights with each counter weight shaped like a “C” and with a socket in a center area of the counter weight; and
wherein the pivot arm further comprises a ball connection at a second end coupled to the socket of the counter weight thereby constraining the pivot arm from co-rotating with the rotating shaft.

4. The waterfowl motion decoy of claim 3, wherein each counter weight has two bearings at opposite ends of the counter weight.

5. The waterfowl motion decoy of claim 1, wherein each swivel joint is coupled to the housing and a gear train so that, when the gear train is driven by a force, each swivel joint pivots the wing adapter about a pivot axis and rotates the wing adapter about a rotation axis.

6. The waterfowl motion decoy of claim 5, wherein the pivot axis and the rotation axis intersect at an angle between 30 and 60 degrees.

7. The waterfowl motion decoy of claim 5, wherein the pivot axis and the rotation axis intersect at an angle of about 45 degrees.

8. A waterfowl motion decoy comprising:
a housing shaped in the form of a waterfowl;
two wings configured to look like wings of the waterfowl;
a gear train coupled to a drive shaft driven by a force; and
two swivel joints, wherein each swivel joint comprises a wing adapter configured to be coupled to one of the two wings and each swivel joint is coupled to the housing and the gear train so that, when the gear train is driven by the force, each swivel joint pivots the wing adapter about a pivot axis and rotates the wing adapter about a rotation axis.

9. The waterfowl motion decoy of claim 8, wherein the pivot axis and the rotation axis intersect at an angle between 30 and 60 degrees.

10. The waterfowl motion decoy of claim 8, wherein the pivot axis and the rotation axis intersect at an angle of about 45 degrees.

11. The waterfowl motion decoy of claim 8, wherein each swivel joint further comprises:
a pivot arm comprising:
the wing adapter at a first end of the pivot arm configured to be coupled to one of the two wings and
a bearing mount,
a rotating shaft having a first rotating bearing and a second rotating bearing at opposite ends of the rotating shaft,
a swivel bearing connecting the pivot arm to the rotating shaft comprising:
an outer race fixed to the bearing mount of the pivot arm so that the outer race and the pivot arm move as one piece,
an inner race coupled to the outer race so that the inner race can freely spin inside the outer race and
a mounting hub fixed to the inner race and the rotating shaft extends through the mounting hub so that the inner race, the mounting hub and the rotating shaft move as one piece and
wherein each of the two swivel joints is configured to move one of the two wings, back and forth in a linear path and rotate the wing back and forth when the wing reaches a top and a bottom of the linear path.

12. The waterfowl motion decoy of claim 11, wherein the pivot arm is constrained from co-rotating with the rotating shaft by a horizontal edge of an opening in the housing.

13. The waterfowl motion decoy of claim 11, further comprising:
two counter weights with each counter weight shaped like a “C” and with a socket in a center area of the counter weight; and
wherein the pivot arm further comprises a ball connection at a second end coupled to the socket of the counter weight thereby constraining the pivot arm from co-rotating with the rotating shaft.

14. The waterfowl motion decoy of claim 13, wherein each counter weight has two bearings at opposite ends of the counter weight.

15. A waterfowl motion decoy comprising:
a housing configured to look like a body of a waterfowl;
two wings configured to look like wings of the waterfowl; and
a chassis mounted in the housing configured to move each of the two wings back and forth in a linear path and rotate each wing back and forth when the wing reaches a top and a bottom of the linear path.

16. The waterfowl motion decoy of claim 15, further comprising:
two swivel joints coupled inside the chassis, wherein each swivel joint comprises:
a pivot arm comprising:
a wing adapter at a first end of the pivot arm configured to be coupled to one of the two wings and
a bearing mount,
a rotating shaft having a first rotating bearing and a second rotating bearing at opposite ends of the rotating shaft,
a swivel bearing connecting the pivot arm to the rotating shaft comprising:
an outer race fixed to the bearing mount of the pivot arm so that the outer race and the pivot arm move as one piece,
an inner race coupled to the outer race so that the inner race can freely spin inside the outer race and
a mounting hub fixed to the inner race and the rotating shaft extends through the mounting hub so that the inner race, the mounting hub and the rotating shaft move as one piece.

17. The waterfowl motion decoy of claim 16, wherein the pivot arm is constrained from co-rotating with the rotating shaft by a horizontal edge of an opening in the housing.

18. The waterfowl motion decoy of claim 16, further comprising:
two counter weights with each counter weight shaped like a “C” and with a socket in a center area of the counter weight; and
wherein the pivot arm further comprises a ball connection at a second end coupled to the socket of the counter weight thereby constraining the pivot arm from co-rotating with the rotating shaft.

19. The waterfowl motion decoy of claim 18, wherein each counter weight has two bearings at opposite ends of the counter weight coupled to the chassis.

20. The waterfowl motion decoy of claim 15, wherein the chassis is configured to move the two wings as mirror images about a head-to-toe centerline of the housing.
